(19) United States
(12) Patent Application Publication
(10) Pub. No.: US 2018/0191744 A1
(43) Pub. Date: Jul. 5, 2018

(54) SYSTEM AND METHOD TO IMPLEMENT CLOUD-BASED THREAT MITIGATION FOR IDENTIFIED TARGETS

(71) Applicant: Arbor Networks, Inc., Burlington, MA (US)

(72) Inventors: Carlos E. Morales, Leominster, MA (US); Scott Iekel-Johnson, Ann Arbor, MI (US)

(73) Assignee: Arbor Networks, Inc., Burlington, MA (US)

(21) Appl. No.: 15/399,368

(22) Filed: Jan. 5, 2017

(51) Int. Cl. H04L 29/06

(52) U.S. Cl. CPC H04L 63/1408; H04L 63/0245; H04L 63/1441

(57) ABSTRACT

An on-premises network protection system and method for providing on-premises network protection are provided. The system includes a memory configured to store instructions and a processor disposed in communication with the memory, wherein the processor upon execution of the instructions is configured to receive notification that a characteristic of premises-based network traffic associated with at least one identified target of a network attack exceeds a predetermined threshold, and submit, based on the notification, a request, that identifies the at least one identified target, to a cloud-based protection system to provide cloud-based threat mitigation for a portion of network traffic associated with the at least one identified target.

### FIELD OF THE INVENTION

The disclosed embodiments generally relate to computer network protection, and more particularly, to implementing cloud-based threat mitigation for identified targets.

### BACKGROUND OF THE INVENTION

Networks are constantly exposed to security exploits that are of significant concern to network providers. For example, Denial of Service (“DoS”) attacks can cause significant damage to networks and networked hosts. A DoS attack is defined as an action taken upon on a computer network or system by an offensive external host that prevents any part of the network from functioning in accordance with its intended purpose. This attack may cause a loss of service to the users of the network and its network hosts. For example, the loss of network services may be achieved by flooding the system to prevent the normal servicing for performing legitimate requests. The flooding may consume all of the available bandwidth of the targeted network or it may exhaust the computational resources of the targeted system.

A distributed denial of service (DDoS) attack is a more aggressive action that involves multiple offensive hosts performing an attack on a single target computer network or system. This attack may be performed in a coordinated manner by these multiple external hosts to attack a specific resource of a victim's network. The targeted host can be any networking device such as routers, Internet servers, electronic mail servers, Domain Name System (“DNS”) servers, etc. Examples of a DDoS attack include (but are not limited to): large quantities of attack traffic designed to overwhelm a resource or infrastructure; application specific attack traffic designed to overwhelm a particular service; attack traffic formatted to disrupt a host from normal processing; attack traffic reflected and/or amplified through legitimate hosts; attack traffic originating from compromised sources or from spoofed internet protocol (IP) addresses; and pulsed attacks (which repeatedly start/stop).

Countermeasures can be applied to thwart network security threats. However, when countermeasures are over aggressive, they can block legitimate network traffic. On the other hand, when such countermeasures are too lenient, security threats can be transmitted without portions of the attack traffic being mitigated, posing a security threat that can compromise network service to a network's hosts and users. Since network security threats vary with time, countermeasures that are appropriate when first applied can eventually become over aggressive or too lenient.

Premises-based attack protection can be provided close to a protected network, such as an enterprise network, such as to provide continual (always-on) protection from an attack. However, premises-based attack protection has limited bandwidth that can be overwhelmed by a large attack. A solution has been to request cloud-based attack protection from a cloud-based attack protection system when a large attack is detected by a system providing the premises-based attack protection. The premises-based attack protection system may request cloud-based attack protection services when it has detected that a total rate of network traffic entering the premises-based attack protection system has exceeded a threshold.

When the cloud-based attack protection system receives the request from the premises-based protection system, it can initiate mitigation for all networks protected by the premises-based protection system. This may include portions of the network that are directly under attack and portions of the network that are not under attack. This may contribute to incidental blocking of legitimate traffic that was not involved in the attack.

Such conventional methods and systems have generally been considered satisfactory for their intended purpose. However, there is still a need in the art for providing finer tuned cloud-based attack protection. The present disclosure provides a solution for these problems.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, disclosed is a premises-based network protection system for providing on-premises network protection. The system includes a memory configured to store instructions and a processor disposed in communication with the memory, wherein the processor upon execution of the instructions is configured to receive notification that a characteristic of premises-based network traffic associated with at least one identified target of a network attack exceeds a predetermined threshold, and submit, based on the notification, a request, that identifies the at least one identified target, to a cloud-based protection system to provide cloud-based threat mitigation for a portion of the network traffic associated with the at least one identified target.

In accordance with another aspect of the disclosure, a computer-implemented method is disclosed to provide premises-based network protection. The method includes receiving notification that a characteristic of premises-based network traffic associated with at least one identified target of a network attack exceeds a predetermined threshold, and that at least one host is a proper subset of the plurality of hosts, and submitting, based on the notification signal, a request signal, that identifies the at least one identified target, to a cloud-based protection system to provide cloud-based threat mitigation for a portion of the network traffic associated with the at least one identified target.

In accordance with still another aspect of the disclosure, a non-transitory computer readable storage medium and one or more computer programs embedded therein are provided. The computer programs include instructions, which when executed by a computer system, cause the computer system to perform the operations of the method.

In accordance with a further aspect of the disclosure, a cloud-based attack protection system includes a memory configured to store instructions and a processor disposed in a cloud-based network and in communication with said memory. The processor upon execution of the instructions is configured to receive a request from a premises-based network protection system that identifies at least one identified target, and requests cloud-based attack protection to the at least one identified target, and provide the cloud-based attack protection for a portion of the network traffic associated with the at least one identified target.

In embodiments, the target of the attack is at least one host that is a proper subset of a plurality of hosts, the plurality of hosts being coupled to a protected premises network, wherein the network traffic associated with the at least one host has a destination to the at least one host.

Furthermore, in embodiments, the target of the attack is a specified application or a specified network protocol, as specified by at least one of port, protocol, and/or payload information in the network traffic associated with the specified network protocol uses the specified network protocol. Additionally, in embodiments, the cloud-based attack protection system has the capability to mitigate a higher attack volume than mitigation provided by the on-premises network protection system.

In embodiments, the cloud-based attack protection system diverts traffic associated with the target identified in the request from the on-premises attack protection system for attack mitigation by the cloud-based attack protection system. Furthermore, in embodiments, the diversion is performed at least one of automatically without requiring operator intervention, or response to an operator generated request.

Additionally, in embodiments, the cloud-based attack protection system diverts only network traffic having a predetermined minimum subnet size. Furthermore, in embodiments, the network traffic enters the cloud-based attack protection system and is diverted internally within the cloud-based attack protection system for attack mitigation by the cloud-based attack protection system. In addition, in embodiments, the network traffic is received by the cloud-based attack protection system from a source that is external to the cloud-based attack protection system.

### BRIEF DESCRIPTION OF THE DRAWINGS

The accompanying app dices and/or drawings illustrate various non-limiting, example, inventive aspects in accordance with the present disclosure:

FIG. 1 illustrates a block diagram of an example network system, in accordance with an illustrative embodiment of the present disclosure;

FIG. 2 illustrates a block diagram of an example premises-based protection system of a network system, in accordance with an illustrative embodiment of the present disclosure;

FIG. 3 illustrates a block diagram of an example cloud-based protection system of a network system, in accordance with an illustrative embodiment of the present disclosure;

FIG. 4 illustrates a flowchart of an example method for providing premises-based network protection in accordance with an illustrative embodiment of the present disclosure;

FIG. 5 illustrates a flowchart of an example method for providing cloud-based network protection, in accordance with an illustrative embodiment of the present disclosure; and

FIG. 6 illustrates a schematic block diagram of an example computer system that implements the premises-based protection system shown in FIG. 2 and the cloud-based protection system shown in FIG. 3, in accordance with an illustrative embodiment of the present disclosure.

### DETAILED DESCRIPTION OF CERTAIN EMBODIMENTS

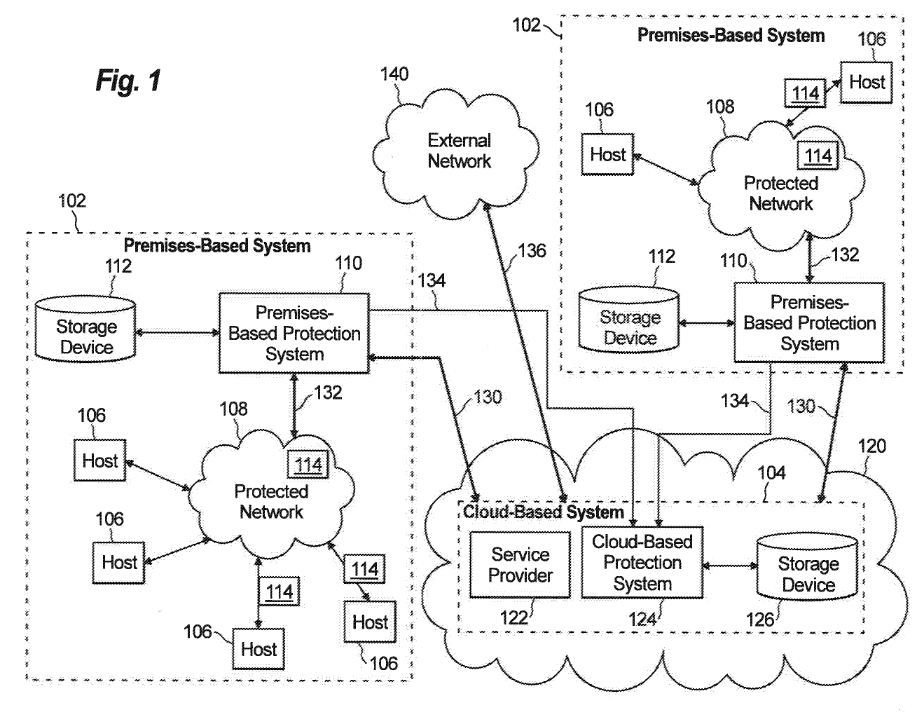

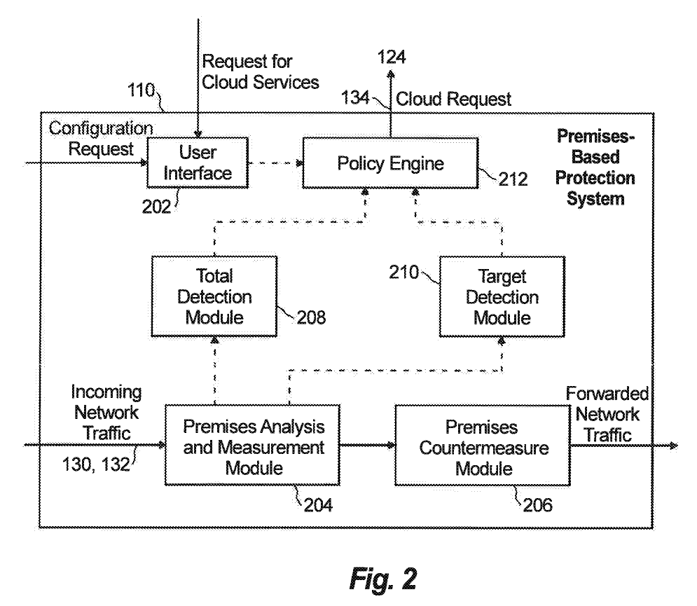

Reference will now be made to the drawings wherein like reference numerals identify similar structural features or aspects of the subject disclosure. For purposes of explanation and illustration, and not limitation, a block diagram of an exemplary embodiment of a network system in accordance with the disclosure is shown in FIG. 1 and is designated generally by reference character 100. Other embodiments of the network system 100 in accordance with the disclosure, or aspects thereof, are provided in FIGS. 2-6, as will be described.

With reference to FIGS. 1-6, a network system is described in which a premises-based protection system can identify targets of a network attack and request cloud-based help from a cloud-based protection system for network traffic associated with the identified targets. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a disc, a memory storage device, or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

Description of certain illustrated embodiments of the present disclosure will now be provided. With reference now to FIG. 1, network system 100 includes at least one premises data communication system 102 (also referred to as the premises-based system 102) and at least one cloud-based data communication system 104 (also referred to as the cloud-based system 104).

With reference to one of the example premises-based systems 102, a plurality of hosts 106 are coupled to a protected network 108. The hosts 106 can be, for example, mobile computing devices, smart phones, servers, media servers, stationary computing devices, sensors, network devices, etc.

The hosts 106 can communicate with other hosts 106 that are coupled to the same network or a different network via the protected network 108. Network traffic can be transmitted to and from the hosts 106 via one or more communication links. These communication links can be wireless, wired, or a combination thereof. Furthermore, these communication links can be included in a virtual private network (VPN) that extends the private network of the protected network 108 on top of a bigger network, which can be a public network. Examples of such public networks include the Internet, a wireless network, a cellular network, a personal communication service (PCS) network, and a public switched telephone network (PSTN).

The protected network 108 can include, for example, a private network, an intranet, a large area network (LAN), a VPN, a personal area network (PAN), a campus network, an enterprise private network, a home area network, a storage area network, a datacenter, a hosting network, an Internet-connected enterprise network (public or private), a branch office network, or a high value portion of one of the above networks, etc.

The protected network 108 and the hosts 106 that communicate via the protected network 108 are protected by a premises-based protection system 110. Under this protection, the hosts 106 can communicate, via the cloud-based system 104, with one another as well as with one or more external networks and hosts using an external network.

The premises-based protection system 110 can detect conditions that indicate the presence of a network attack based on a characteristic of total network traffic. Examples of network attacks include an application-layer distributed denial of service (DDoS) attack, a connection based DDoS attack, a state-exhaustion based DDoS attack, a protocol based DDoS attack, and a volumetric based DDoS attack. One or more targets of the attack can include one or more hosts 106 of the total hosts 106 of the premises-based system 102, wherein the destination of the attack traffic is the one or more targets.

In addition, the premises-based protection system 110 can identify the one or more targets of the network attack. Additionally, the premises-based protection system 110 can detect a characteristic of premises-based network traffic associated with the identified target and determine when the characteristic exceeds a predetermined threshold.

The characteristic of network traffic can include a measurement of network traffic associated with the identified target, wherein the measurement is at least one of traffic rate or volume, or change in traffic rate or volume. The characteristic of network traffic can also include measurement of traffic rate or volume of subsets of the network traffic associated with specific network protocols and including types of messages associated with specific protocols, including but not limited to TCP Syn packets, UDP packets, or ICMP packets. The characteristic of network traffic can also include measurement of applications, e.g., application payload information, wherein the measurement measures the rate or volume of specific application-level messages or actions. Specific examples include HTTP requests, DNS requests, TCP Connections, VOIP (SIP) calls, or application messages containing payload information matching signatures of known malicious traffic.

The characteristic of the network traffic can be compared to a threshold value or to different threshold values based on the different hosts to which the traffic pertains. Threshold values, which can be operator-entered and/or received by another processing device, can be stored in a premises storage device 112 (e.g., a hard-disk drive hard, flash memory, optical drive, external hard drive) and accessed by the premises-based protection system 110. Each respective threshold value can be associated with one or more attributes that indicate a type of traffic measurement characteristics to which the threshold value should be compared.

One attribute can be total or relative. If the threshold value has an attribute of total, the threshold value would be compared to a traffic measurement characteristics associated with total network traffic. If the threshold value has an attribute of relative, a relative type attribute indicates to which type of traffic measurement characteristics the threshold value is relative. For example the relative type attribute can indicate that the threshold value is relative to a historical traffic measurement characteristics associated with a particular time (e.g., previous month, a particular month (e.g., April 2014), previous day, previous minute). In embodiments, the relative type attribute can indicate that the threshold value is relative to an identified one or more targets, such as hosts 106, links, applications, or network protocols.

The threshold value can further be associated with a characteristic type attribute that specifies the type of traffic measurement characteristics. The characteristic type attribute can be, for example, traffic volume for a particular time period, or traffic rate. In additions, the threshold value can further be associated with a statistic type attribute that specifies the a statistical type the threshold value represents, such as average, peak, minimum, total, or mean value.

The cloud-based system 104 is deployed and accessed via a second network 120. The second network 120 can include, for example, a network such as the Internet, a different public network, a wide area network (WAN), and a metropolitan area network (MAN).

The cloud-based system 104 includes a service provider 122, a cloud-based protection system 124, and a storage device 126 (e.g., a hard-disk drive hard, flash memory, optical drive, external hard drive). The service provider 122 provides online services or network access. The service provider 122 can include the facilities to provide these services or use facilities owned by another. Services provided by the service provider 122 can include the transmission, routing, or providing of connections for digital online communications, between or among hosts 106 specified by a user, of material of the user's choosing.

Network traffic can be transmitted from the cloud-based system 104, as facilitated by the service provider 122, along data paths 130 and 132 to the protected network 108. The service provider 122 facilitates transmission of the network traffic, which passes through the premises-based protection system 110. The premises-based protection system 110 can detect the presence of a network attack, including detecting the target of an attack, such as one or more hosts 106, one or more applications, and one or more network protocols. The premises-based protection system 110 uses thresholds to determine whether it can handle the attack by applying premises-based countermeasures, or cloud-based help is needed for applying cloud-based countermeasures.

The network traffic exits the premises-based protection system 110 and enters the protected network 108 via data path 132. At this stage, the network traffic transmitted along data path 132 has been treated by any premises-based countermeasures applied by the premises-based protection system 110. If cloud-based help is needed, the premises-based protection system 110 submits a request for help to the cloud-based protection system 124 via data path 134. The request can identify the target(s) of the attack in order to request cloud-based help for network traffic associated with the target(s). In scenarios, the request may not identify a target of the attack, but rather request cloud-based help for all network traffic.

Data paths 130, 132, 134, and 136 can include wired and wireless links for transmitting network traffic. These links can be secured links included in a VPN that extends the protected network 108 and maintain it as a private network. Data path 134, via which requests for cloud-based help are transmitted, can be out-of-band relative to the links used for network traffic between the protected network 108 and the cloud-based system 104, such as using a different network or data channel.

Internal data communicated between hosts 106 of the protected network 108 can enter the premises-based protection system 110 via data path 132. Intercept devices 114, which can be central or distributed about the protected network 108, its hosts 106, and its communication links, can intercept, capture, route, and/or copy data packets transmitted to the hosts 106 via data path 132 and internal data paths of the protected network 108.

The intercept devices 114, which are optional, can include, for example, probes or taps that are configured to intercept, capture, route, and/or make copies of network traffic data packets. The intercept devices 114 can include hardware or firmware devices, and can include software modules, which can include software agents. Additionally, one or more of the intercept devices 114 can be a virtual intercept device that uses and/or shares hardware devices with other software modules, wherein, for example, the hardware devices can be positioned at locations remote from a location at which the intercept device 114 operates.

The premises-based protection system 110 can be installed inline so that it intercepts all traffic between the premises-based system 102 and the cloud-based system 104 that traverses path 132, including traffic to-and-from the external network 140 (e.g., the Internet). The intercept devices 114 would be needed if traffic that does not traverse link 132 enters the premises-based protection system 110.

The premises-based protection system 110 and the storage device 112 can be independent devices that are coupled to one another, integrated in a single device, or share one or more hardware or software components. Additionally, the premises-based protection system 110 and the storage device 112 can be implemented as physical or virtual devices. Whether implemented as a physical or virtual device, premises-based protection system 110 and the storage device 112 use a hardware processing device that executes software instructions, which enables performance of the disclosed functions.

The premises-based protection system 110, whether configured in combination or separate from the storage device 112, includes a central processing unit (CPU), random access memory (RAM), and a storage medium, which can be connected through buses and used to further support the processing of the received packets. Programmable instructions can be stored in the storage medium and executed by the CPU to cause the CPU to perform operations described herein. The storage medium can also store analyzing criteria for storing program data associated with operation of the premises-based protection system 110.

In embodiments, at least portions of the premises-based protection system 110 and the storage device 112 are external to the protected network 108. The term “premises-based” indicates that at least portions of the premises-based protection system 110 and the storage device 112 are located at a network edge (inside or outside of the protected network 108), and/or internal to the protected network 108, which can include deeper within the protected network 108.

In response to the request for cloud-based help, the cloud-based protection system 124 uses routing protocol methods to divert network traffic for the target host or hosts identified in the request for cloud-based help to the cloud-based protection system 124 and applies cloud-based countermeasures to this network traffic. In some cases, due to limitations of the network routing policies, traffic for hosts that are not the target of attack must be included in the traffic diverted to the cloud-based protection system 124. In this case, cloud-based countermeasures are only applied to traffic having a destination that matches the one or more targets identified in the request for cloud-based help, while the traffic for other hosts is simply passed.

In this way, the cloud-based protection system 124 can avoid applying cloud-based countermeasures to network traffic that is not targeted, which may avoid unnecessary blocking of legitimate traffic. When the request does not identify a specific target, the cloud-based countermeasures can be applied to the total network traffic that enters the cloud-based protection system 124.

The cloud-based protection system 124 can apply specific countermeasures to network traffic based on the target for which the request for cloud-based help was requested. The different countermeasures available for the different targets can be entered by an operator and stored in the cloud-based storage device 126. Operators can establish a correspondence between countermeasures and respective hosts, so that the countermeasures that correspond to each host that is being targeted is applied to the network traffic to that host.

In addition, the cloud-based system 104 can receive network traffic from an external network, such as a private network or a public network, e.g., the Internet, a wireless network, a cellular network, a personal communication service (PCS) network, and a public switched telephone network (PSTN). This external network traffic can be destined for one or more hosts 106 associated with different downstream premises-based systems 102.

In addition to responding to requests from the premises-based protection system 110, the cloud-based protection system 124 detects network attacks and applies corresponding countermeasures. The attack detection and corresponding application of countermeasures by the cloud-based protection system 124, which is performed on a much larger scale, can use the same countermeasure mechanisms used by the premises based protection system.

The cloud-based system 104 is upstream from the premises-based system 102. External traffic arriving in the cloud-based system 104 from an external network 140 is handled by the cloud-based protection system 124. External traffic that has a destination included in a particular premises-based system 102 is received by the premises-based protection system 110 of that premises-based system 102. The premises-based protection system 110 can identify targets of a large scale network attack and transmit a request to the cloud-based protection system 124 to apply countermeasures to network traffic associated with the identified targets. The cloud-based help will be applied after the request is transmitted on an on-going basis until a predetermined condition is reached, such as expiration of a predetermined time interval or a decrease in the amount of traffic blocked by the cloud-based help.

Since the premises-based protection system 110 is downstream from the cloud-based protection system 124, coarser countermeasure may be used by the cloud-based protection system 124 to mitigate a portion of the attack traffic within the network traffic allowing the premise-based protection system 110 to perform more surgical mitigation on the remaining network traffic.

In embodiments, any of the premises-based systems 102 can be based in the cloud, such as by being included in the second network 120 or a cloud associated with the external network 140. For example, the premises-based system 102 can be physically disposed in the cloud. In this case, traffic would be routed through the premises-based system 102 while it is disposed in the second network 120. Logically the premises-based system 102 (while disposed in the second network) functions in the same way it would if it were physically disposed on the premises of the protected network. In this case, the cloud-based protection system 124 is still upstream from the premises-based system 102 (while disposed in the second network) and operates in the same way.

With reference to FIG. 2, the premises-based protection system 110 is shown, which includes a user-interface 202, a premises analysis and measurement module 204, a premises countermeasure module 206, a total detection module 208, a target detection module 210, and a policy engine 212. Modules 204, 208, 210, and 212 can be implemented as software, hardware, firmware, or a combination thereof. Modules 204, 208, 210, and 212 can be executed by a single processing device or multiple processing devices that are included in the premises-based protection system 110. One or more of modules 204, 208, 210, and 212 can be combined or share software, hardware, or firmware components.

An operator can enter threshold values for specified targets by entering a configuration request via the user interface module 202. In embodiments, the configuration request can be received from another processing device (not shown). User interface module 202 can include one or more interfaces that communicate with a user input device (e.g., a touchscreen, keyboard, cursor control device (e.g., mouse), etc.) and/or a user output device (e.g., display screen (such as the touchscreen), printer) to receive input data. The user interface can provide a graphical user interface (GUI) that an operator can operate via the user input device for entering data.

The configuration request can further configure the premises-based protection system 110 to monitor for an attack based on particular attributes, such as measured traffic characteristics type (e.g., traffic volume over a specified time limit or traffic rate), specified target types (e.g., one or more hosts, applications, and/or network protocols), determining particular types of statistics (e.g., average, mean, peak, minimum) associated with network traffic over a specified time interval, and/or comparing the measured traffic characteristics to an absolute threshold value or to a relative value (e.g., another measured traffic characteristic). The configuration request can further specify the other measured traffic characteristic to which the measured traffic characteristics are compared, such as measurements associated with a historic time interval or a different target.

In addition, the user interface 202 can output information to the operator or the other processing device about results generated by the other modules 204, 208, 210, and 212. The user output device can include, for example, a display device or a printer. The user interface module 202 can provide a GUI that can be displayed on the user output device. The user interface module 202 can generate a single GUI that can both receive user input data and display results generated by the other modules 204, 208, 210, and 212 to the operator. Additionally, a user can enter a request for cloud-based help via the user interface 202. This request can be processed by the policy engine 212.

The premises analysis and measurement module 204 receives incoming network traffic via data paths 130 and 132 and any configuration requests. The data path 130 provides network traffic from the upstream service provider 122. The data path 132 provides internal network traffic of the protected network 108 that is being forwarded to the upstream network provider over data path 130, including traffic sent from the intercept devices 114 and from any other hosts on the protected network 108 that are sending traffic over link 132 to the upstream provider.

The premises analysis and measurement module 204 analyzes the incoming network traffic and measures characteristics of this data based on a configuration of the premises-based protection system 110. The premises-based protection system 110 can be configured via an operator-entered configuration request, a configuration request entered by a processing device (not shown), and/or by default value.

The premises analysis and measurement module 204 can measure and/or compute traffic characteristics based on different attributes that were specified in the configuration request, such as target type (total network traffic, one or more identified hosts which are the destination of the network traffic, applications, or network protocols), traffic characteristic type (e.g., traffic volume for a particular time period, or traffic rate), statistic type (e.g., average, peak, minimum, total, or mean value).

The analysis can include inspection of data packets of the incoming network traffic. Because the premise-based protection system 110 processes network traffic directly, it can provide analysis and detection based on all seven layers of the OSI model to determine the destination of an attack. The packet inspection can include examination of an internet protocol (IP) header, IP protocol header and/or application data within each packet received.

The premises countermeasure module 206 receives the network traffic that was analyzed and measured by the premises analysis and measurement module 204, applies countermeasures to block traffic identified by the countermeasures as attack traffic, and forwards traffic identified by the countermeasures as legitimate traffic. Blocked attack traffic is not output from the premises-based protection system 110 as network traffic for transmission to its designated destination. Forwarded legitimate traffic is output from the premises-based protection system 110 as network traffic for transmission to its designated destination.

The premises countermeasure module 206 can decide, by applying filters, which traffic to block and which traffic to forward. The filters may include blacklists that specify which traffic to block and whitelists that specify which traffic to forward. The premises countermeasure module 206 can also participate in adding or removing entries from the blacklists and whitelists that it uses, however formation of the blacklists and whitelists is beyond the scope of the current disclosure.

If a large scale attack is underway, the premises countermeasure module 206 can continue to operate as usual, but may not be able to counteract the attack. However, a request can be submitted for cloud-based help by the detection module 208, which will enlist upstream help from the cloud-based system 104. Since the cloud-based help is provided upstream, the network traffic arriving via data path 130 will include network traffic that was forwarded by the cloud-based system 104 after applying its countermeasures on a larger scale than possible by the premises-based protection system 110. Accordingly, the amount of traffic filtering that needs to be done by the premises-based protection system 110 will be within the scope of the premises countermeasure module 206 until help needs to be requested again, such as if a different type of attack launched or a different target is targeted.

The total detection module 208 compares traffic characteristic measurements associated with total network traffic entering the premises countermeasure module 206 to at least one corresponding total traffic threshold value, e.g., that is stored in first storage device 112. Based on the configuration of the premises-based protection system 110, measurements for one or more traffic characteristics associated with the total traffic can be compared to threshold values for corresponding total traffic characteristics.

The configuration request defines, for example, characteristic measurement type (e.g., traffic volume or rate) to be measured and/or compared to a threshold value, whether the traffic characteristic measurement is compared to an absolute or relative type threshold value, the type of threshold value to which the traffic measurement characteristic is compared, the type of statistic computed for the measurements, and the statistic type of the threshold value to which the computed statistical value associated with the traffic measurement characteristic is compared.

The threshold value can be an absolute value, such as a traffic rate measurement, a traffic volume measurement, or a statistic. In embodiments, the threshold value can be a relative value, such as a previous measurement of the same total traffic characteristic associated with a specified time interval as indicated by the configuration. Using a threshold value that is a relative value provides for comparing current operation to historical operation.

A threshold value is selected from the stored threshold values based on the configuration and the attributes of the stored threshold values. If a total traffic threshold value is exceeded, then the total detection model 208 transmits a request to the policy engine 212 requesting cloud-assisted help for the total network traffic. The request identifies the traffic characteristic(s) measurement that exceeded the threshold value.

The target detection model 210 compares a traffic characteristic measurement associated with each of the targets of the network traffic entering the premises countermeasure module 206 to at least one corresponding total traffic threshold value, e.g., that is stored in first storage device 112. Based on the configuration of the premises-based protection system 110, measurements for one or more traffic characteristics associated with a particular target can be compared to threshold values for corresponding total traffic characteristics for a corresponding target.

The configuration request defines, for example, characteristic measurement type (e.g., traffic volume or rate) to be measured and/or compared to a threshold value, whether the traffic characteristic measurement is compared to an absolute or relative type threshold value, identification of the target, the type of threshold value to which the traffic measurement characteristic is compared, the type of statistic computed for the measurements, and the statistic type of the threshold value to which the computed statistical value associated with the traffic measurement characteristic is compared.

The threshold value can be an absolute value, such as a traffic rate measurement, a traffic volume measurement, or a statistic. In embodiments, the threshold value can be a relative value, such as a previous measurement of a traffic characteristic associated with the same or a different target for a time interval specified by the configuration. Using such a threshold value that is a relative value provides for comparing current operation to historical operation and for comparing operation of different targets.

A threshold value is selected from the stored threshold values based on the configuration and the attributes of the stored threshold values. If a threshold value for the specified target is exceeded, then the target detection model 210 transmits a request to the policy engine 212 requesting that this target be included in any cloud-assisted help that is requested from the total detection module 208 for the network traffic associated with the target. The request identifies the target and the traffic characteristic measurement that exceeded the threshold value.

The policy engine 212 receives requests for help from either the user interface or the total detection module 208 and further receives information from the target detection module 210, In response, the policy engine 212 formats and sends a cloud request (such as via data path 134) to the cloud-based protection system 124. The cloud request requests cloud-assisted help to mitigate attack traffic for either the total network traffic or one or identified targets. The cloud request can include the information that was provided in the requests for cloud-assisted help from the total detection module 208 or the target detection module 210. Additionally, the cloud request identifies the particular premises-based system that is sending the cloud request.

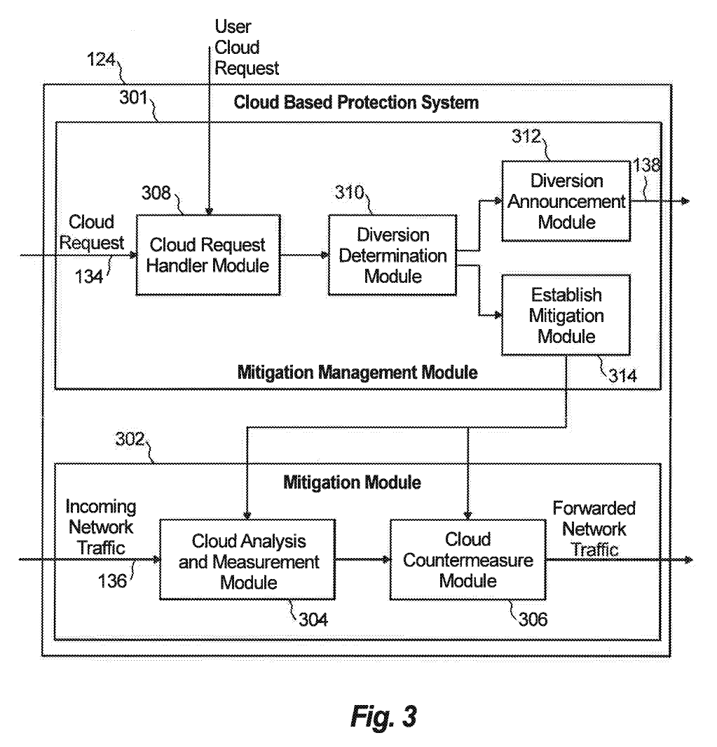

With reference to FIG. 3, the cloud-based protection system 124 is shown, which includes a mitigation management module 301 and a mitigation module 302. The mitigation module 302 includes a cloud analysis and measurement module 304 and a cloud countermeasure module 306. The mitigation management module 301 includes a cloud request handler module 308, diversion determination module 310, diversion announcement module 312, and establish mitigation module 314.

Modules 301, 302, 304, 308, 310, 312, and 314 can be implemented as software, hardware, firmware, or a combination thereof. Modules 301, 302, 304, 308, 310, 312, and 314 can be executed by a single processing device or multiple processing devices that are included in the cloud-based protection system 124. One or more of modules 301, 302, 304, 308, 310, 312, and 314 can be combined or share software, hardware, or firmware components.

The cloud request handler module 308 interfaces with the premises-based protection system 110 (shown in FIG. 2) to receive a cloud request, e.g., via data path 134 shown in FIG. 1, or via a user cloud request. The cloud request can also be submitted via a user input device (not shown) that interfaces with the mitigation management module 301. The mitigation management module 301 can include a user interface module (not shown) that interfaces with the user input device. Receipt of the cloud request indicates that the premises-based protection system 110 or a user is requesting cloud-based help to handle an attack. Upon receipt of a cloud request, the cloud request handler module 308 notifies the diversion determination module 310.

Particular configuration settings can be applied for different premises-based systems. Accordingly, the cloud request handler module 308 accesses configuration settings associated with the premises-based system identified by the cloud request, such as by consulting a data structure stored by the cloud-based storage device 126.

The cloud request handler module 308 can access stored information, e.g., stored in storage device 126 shown in FIG. 1, to determine or look up configuration settings to be applied based on information provided in the cloud request. The information provided in the cloud request can include the premises-based system that issued the cloud request, traffic characteristic measurements that were determined to exceed the threshold value(s), and any targeted destinations identified if targeted mitigation is being requested. The cloud request handler module 308 can then provide the relevant configuration settings to each of the modules 304, 306, 310, 312, and 314 to be applied when processing data associated with the premises-based system identified by the cloud request.

Data in the cloud request requests mitigation and can provide relevant configuration settings for each of the modules 306, 308, and 310. Data in the cloud request also provides identification of the premise-mitigation device requesting the mitigation.

The cloud request handler module 308 receives the request and can provide specific configuration information in the request to the cloud countermeasure module 306 to use for distinguishing between legitimate and attack traffic and for minimizing mitigation of non-attack traffic. Furthermore, data in the cloud request provided to the diversion determination module 310 can include specific network destinations for diversion to the cloud.

The diversion determination module 310 examines and deciphers the cloud request to determine whether the cloud request is requesting cloud-based help for total network traffic or for network traffic associated with an identified target. If the cloud request requests cloud-based help for network traffic associated with an identified target, the diversion determination module 310 determines routing or address information associated with the identified target, such as an IP address or classless inter-domain routing (CIDR) data for routing IP packets. The determination of which routing or address information is associated with an identified target can be made, for example, based on information stored, e.g., in storage device 126 shown in FIG. 1, about the identified target.

The routing or address information determined by the diversion determination module 310 can be aggregated to a minimum size classless inter-domain routing (CIDR) based on configuration parameters specified in software and IP address(es) specified in the cloud request and aggregated into the CIDR of which the IP address is a portion, and use the CIDR to enter (e.g., populate) configuration information in modules 312 and 314.

The network traffic identified by the cloud request is automatically diverted using a standardized routing protocol, such as an exterior gateway protocol (e.g., Exterior Gateway Protocol (EGP) such as Border Gateway Protocol (BGP) or by interfacing to a Software Defined Networking (SDN) Controller to redirect the traffic. The diversion can take place independent of operator intervention in response to an automatically generated cloud-request, or in response to an operator request via the premises-based protection system or the cloud-based protection system. Traffic can be diverted from the external network 140 (e.g., the Internet, another public network or another private network) to the cloud-based protection system 124 using path 136.

The diversion determination module 310 can extract a routing prefix for the standardized routing protocol associated with network destinations that correspond to the premises device requesting the cloud-assistance, network destination or destinations requested within the cloud request, the CIDR or CIDRs that contain the network destinations requested in the cloud request, or a network specified by the operator request. The routing prefix can identify a subnet of IP addresses that are a target of an attack and for which mitigation is selectively requested. Other IP addresses that are not included in the subnet are not targeted by the attack, and therefore further mitigation by the cloud-based protection system 124 has not been requested via the cloud request.

The diversion announcement module 312 has an established routing protocol connection with the routing infrastructure through path 138. Module 312 announces each routing prefix that was configured by the diversion module 310 out interface 138 to the public Internet, other public network, private network or other network. This will divert network traffic to the specified prefixes via link 136.

The establish mitigation module 314 can take information from the cloud request that it receives from the diversion determination module 308, as well as configuration information stored in software and storage (e.g., storage device 126 shown in FIG. 1), and use this information to provide configuration parameters to the cloud countermeasure module 306 and the cloud analysis and measurement module 304.

For example, the establish mitigation module 314 can use traffic diversion information and cloud request information provided by the diversion determination module 310 to lookup or determine treatment of the incoming network traffic and generate configuration settings for the analysis and measurement module 304 and the cloud countermeasure module 306.

Configuration parameters for the cloud countermeasure module 306 can specify to which network traffic to apply countermeasures, which countermeasures to enable, what settings to apply to the countermeasures, as well as blacklists, whitelists, and rate limits to apply to the network traffic. The cloud countermeasure module 306 applies the configuration parameters when processing network traffic and determining what traffic to pass and what traffic to drop.

The cloud analysis and measurement module 304 receives incoming network traffic from a network that is external to the protected network (e.g., external network 140 shown in FIG. 1 and upstream relative to the protected network 108, such as via data path 136). The cloud analysis and measurement module 304 is configured based on configuration parameters from the mitigation management module 301 that specify which portion of the network traffic should be analyzed.

The cloud analysis and measurement module 304 can refrain from performing any analysis or measurement tasks until it is configured to do so by the mitigation management module 301. When not configured to perform mitigation, the cloud analysis and measurement module 304 and the cloud countermeasure module 306 can enter a wait state, during which the network traffic passes by or through the cloud analysis and measurement module 304 and the cloud countermeasure module 306 such that the network traffic is not processed, blocked, or diverted, but is allowed to be forwarded to its designated destination.

Once configured for mitigation, if mitigation is requested for the total network traffic, the cloud analysis and measurement module 304 performs analysis and measurement tasks to all of the incoming network traffic. However, if mitigation is requested for a specified target, the cloud analysis and measurement module 304 identifies data packets that are destined for that target, and only performs analysis and measurement tasks to the identified packets.

When the target is one or more identified hosts, as identified by one or more IP addresses, the cloud analysis and measurement module 304 identifies data packets that have a destination address that is included with the one or more IP addresses by examining the destination field in an IP portion of the packet. The cloud analysis and measurement module 304 outputs the incoming network traffic, including the packets that it identified. The cloud analysis and measurement module 304 creates records of the traffic that it has analyzed, such as values representing total traffic by bandwidth and by packets per second.

When the configuration parameters identify the target(s) as one or more applications, as identified by payload information or ports on the IP protocols, the cloud analysis and measurement module 304 identifies network traffic for these applications by examining the payload information or IP ports in the network traffic. The cloud analysis and measurement module 304 outputs the incoming network traffic, including the applications that it identified. The cloud analysis and measurement module 304 creates records of the traffic that it has analyzed, including values representing total traffic by bandwidth and by packets per second.

When the configuration parameters identify the target(s) as one or more IP protocols, as identified by the IP protocol field in the network traffic, the cloud analysis and measurement module 304 identifies network traffic for these IP protocols by examining the IP protocol field in the network traffic. The cloud analysis and measurement module 304 outputs the incoming network traffic, including the IP protocols that it identified. The cloud analysis and measurement module 304 creates records of the traffic that it has analyzed including values representing total traffic by bandwidth and by packets per second.

The cloud countermeasure module 306 receives the network traffic output by the cloud analysis and measurement module 304. When the configuration parameters specify mitigation for the total network traffic, the cloud countermeasure module 306 applies countermeasures specified by configuration parameters to all the network traffic.

When the mitigation configuration parameters specify mitigation for network traffic destined for the specified target or set of targets, the cloud countermeasure module 306 applies countermeasures specified by the configuration parameters to only the data packets associated with the target(s) identified in the configuration parameters.

Application of the countermeasures blocks traffic identified by the countermeasures as attack traffic and forwards traffic identified by the countermeasures as legitimate traffic. The cloud countermeasure module 306 can decide, by applying filters, which traffic to block and which traffic to forward. The filters may include blacklists and whitelists. The cloud countermeasure module 306 can also participate in adding or removing entries from the blacklists and whitelists that it uses, however formation of the blacklists and whitelists is beyond the scope of the current disclosure.

The cloud countermeasure module 306 has the capacity to apply countermeasures to a large amount of traffic from various premises-based systems, using countermeasures designated for the premises identified by the cloud request. The capacity of the cloud countermeasure module 306 is larger than the capacity of the premises-based systems in terms of the amount of data it can receive (e.g., its bandwidth) and its processing capacity (e.g., processing speed and volume).

Thus, network system 100 provides surgical attack detection, in which a premises-based system can specify threshold values per specific targets to which network traffic is destined and for which it would require cloud-based assistance to mitigate. The cloud-based countermeasures are applied to only data packets that are identified as destined to the specified target. Other network traffic is not processed for application of countermeasures. Thus, cloud-based mitigation of attacks is performed in a precise manner on data that has been identified at the premises or by the operator as being substantially affected by an attack, without applying cloud-based mitigation to network data that is not substantially affected by the attack and does not need mitigation. Thus, negative side-effects of mitigation are avoided for the network data that is not substantially affected by the attack. Such negative side-effects can include, for example, blocking of legitimate traffic and unnecessary consumption of processing and time resources.

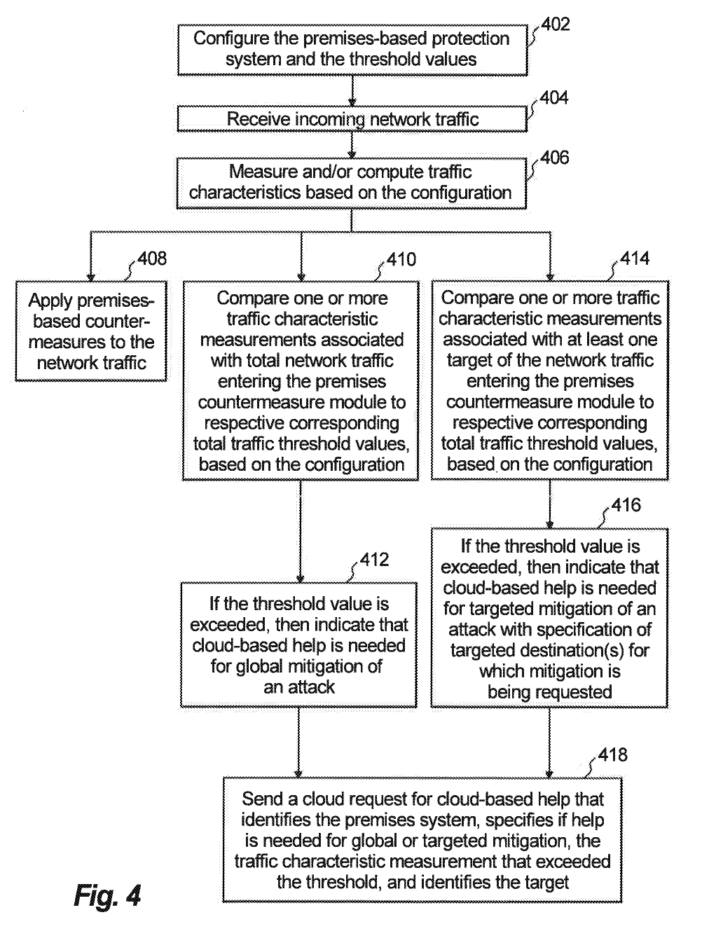

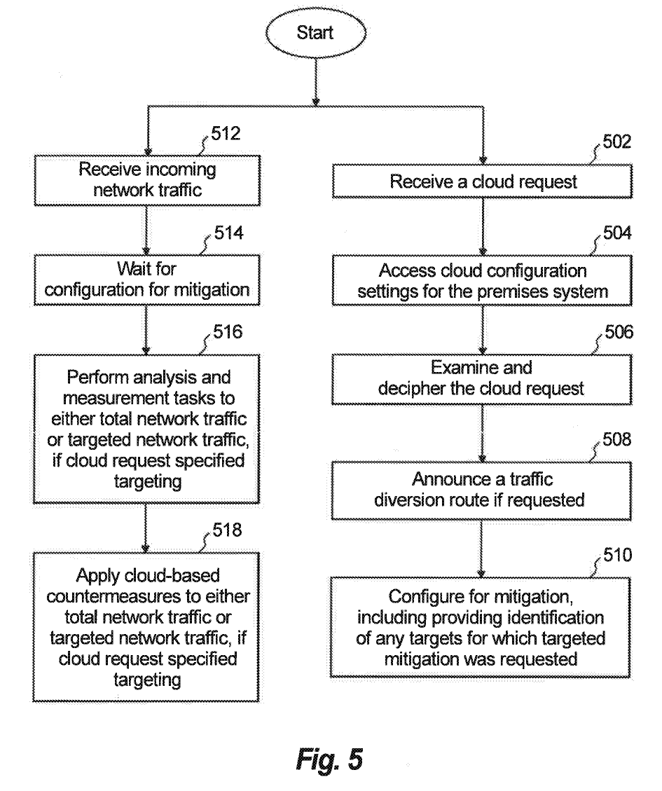

With reference now to FIGS. 4 and 5, shown are flowcharts demonstrating implementation of the various exemplary embodiments. It is noted that the order of operations shown in FIGS. 4 and 5 is not required, so in principle, the various operations may be performed out of the illustrated order or in parallel. Also certain operations may be skipped, different operations may be added or substituted, or selected operations or groups of operations may be performed in a separate application following the embodiments described herein.

With reference to FIG. 4, an example method is shown that can be performed by the premises-based protection system. At operation 402, the premises-based protection system and the threshold values are configured. This can be performed by the manufacturer, and/or by a vendor or operator, such as by receiving, e.g., via operator input or from another processor, threshold values with corresponding attributes and/or a configuration request. At operation 404, incoming network traffic is received. At operation 406, traffic characteristics are measured and/or computed based on the configuration.

The method can continue at any of operations 408, 410, or 414, which can be performed sequentially or in parallel. At operation 408, premises-based countermeasures are applied to the network traffic. Operation 408 can continue to be performed even while operations 410, 412, 414 and/or 416 are performed. In embodiments, when a large-scale network attack is detected for which cloud-based mitigation help is requested, operations 406 and/or 408 can either perform as usual as best as possible, with safety features to avoid failure under attack conditions. Safety features include rate limiting that will limit the amount of traffic processed to a level that is supported by the premises-based system.

At operation 410, one or more traffic characteristic measurements associated with total network traffic entering the premises countermeasure module are compared to respective corresponding total traffic threshold values, based on the configuration. In other words, the traffic characteristic measurement is compared to an absolute or relative value, as indicated by the configuration. This may further include retrieving historical data or data related to a different target, and/or calculating the relative value.

At operation 412, based on the comparison in operation 410, if one of the threshold values is exceeded, then an indication is output that cloud-based help is needed. Without providing additional information about targeted mitigation, this indication for cloud-based help is for global mitigation of an attack. Global mitigation herein refers to mitigation of the total network traffic, as opposed to targeted network traffic.

At operation 414, one or more traffic characteristic measurements associated with at least one target of the network traffic entering the premises countermeasure module is compared to respective corresponding total traffic threshold values, based on the configuration. In other words, the traffic characteristic measurement is compared to an absolute or relative value, as indicated by the configuration. This may further include retrieving historical data or data related to a different target, and/or calculating the relative value.

At operation 416, based on the comparison in operation 414, if the threshold value is exceeded, then an indication is made that cloud-based help is needed and specifies targeted destinations for which mitigation is being requested.

At operation 418, when an indication is output by operations 412 or 416 that cloud-based help is needed for mitigation, a cloud request for cloud-based help is sent The cloud request identifies the premises-based system that has determined cloud-based help is needed and is issuing the cloud request, specifies whether help is needed for global mitigation, specifies the traffic characteristic measurements that were determined to exceed the threshold value(s), and specifies targeted destinations identified in operation 416 for which mitigation is being requested. In embodiments, any of operations 412, 416, and 418 can be combined.

With reference to FIG. 5, an example method performed by a cloud-based protection system, such as cloud-based protection system 124 shown in FIG. 3, is shown. The process beginning at operation 502 can be performed by a module, such as the mitigation management module 301 shown in FIG. 3. The process beginning at operation 512 can be performed by a module, such as the mitigation module 302 shown in FIG. 3. The processes beginning at operation 512 and operation 502 can be performed in parallel or in series.

At operation 502, a cloud request is received. The cloud request can include identification of the premises-based system issuing the cloud request, specifies whether help is needed for global mitigation, specification of the traffic characteristic measurements that were determined to exceed the threshold value(s), and specification of targeted destinations identified in operation 416 for which mitigation is being requested by the cloud request.

At operation 504, cloud configuration settings for the premises-based systems are accessed. At operation 506, the cloud request is examined and deciphered. At operation 508, which is optional, an announcement of a determined traffic diversion route is output. The announcement can include one or more routing prefixes, and can be transmitted to the Internet, or another network, such as another public network private network, or network using an IP routing protocol. At operation 510, configuration parameters are provided to analyze and measure network traffic and apply countermeasures, including for targeted mitigation.

At operation 512, incoming network traffic is received. At operation 514, a wait step is performed until configuration is set for mitigation, such as by performance of operation 510. At operation 516, analysis and measurement tasks are performed to either total network traffic or targeted network traffic, based on configuration parameters of the configuration that was set. The analysis and measurement can include identifying traffic, counting amounts of traffic to determine traffic levels, e.g., in terms of bits per second and packets per. The results of the analysis and measurement can be stored in memory.

At operation 518, countermeasures are applied to either total network traffic or targeted network traffic, depending on whether the cloud request and configuration parameters specified that targeted mitigation should be performed, as opposed to mitigation to total network traffic. The countermeasures applied are those countermeasures specified in by the configuration parameters. When targeted mitigation is specified in the configuration parameters, the countermeasures are applied to the attack traffic identified in the configuration parameters.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

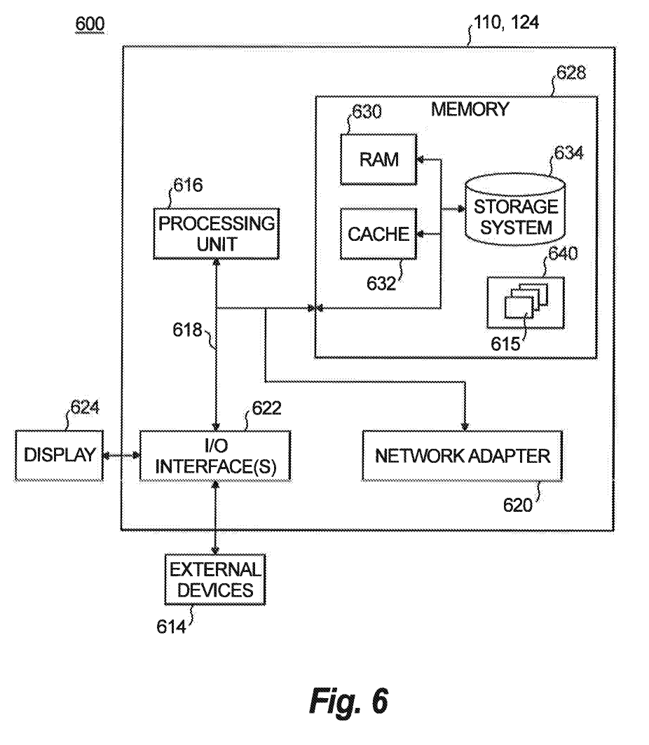

Embodiments of the threat management system shown in FIG. 1 may be implemented or executed by one or more computer systems. For example, the premises-based protection system 110 and/or the cloud-based protection system 124 can be implemented using a computer system such as example computer system 602 illustrated in FIG. 6. In various embodiments, computer system 602 may be a server, a mainframe computer system, a workstation, a network computer, a desktop computer, a laptop, or the like, and/or include one or more of a field-programmable gate array (FPGA), application specific integrated circuit (ASIC), microcontroller, microprocessor, or the like.

Computer system 602 is only one example of a suitable system and is not intended to suggest any limitation as to the scope of use or functionality of embodiments of the disclosure described herein. Regardless, computer system 602 is capable of being implemented and/or performing any of the functionality set forth hereinabove.

Computer system 602 may be described in the general context of computer system-executable instructions, such as program modules, being executed by a computer system. Generally, program modules may include routines, programs, objects, components, logic, data structures, and so on that perform particular tasks or implement particular abstract data types. Computer system 602 may be practiced in distributed data processing environments where tasks are performed by remote processing devices that are linked through a communications network. In a distributed data processing environment, program modules may be located in both local and remote computer system storage media including memory storage devices.

Computer system 602 is shown in FIG. 6 in the form of a general-purpose computing device. The components of computer system 602 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 602 typically includes a variety of computer system readable media. Such media may be any available media that is accessible by the premises-based protection system 110 and/or the cloud-based protection system 124, and it includes both volatile and non-volatile media, removable and non-removable media.

System memory 628 can include computer system readable media in the form of volatile memory, such as random access memory (RAM) 630 and/or cache memory 632. Computer system 602 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the disclosure.

Program/utility 640, having a set (at least one) of program modules 615, such as computer system 602, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the disclosure as described herein.

Computer system 602 may also communicate with one or more external devices 614 such as a keyboard, a pointing device, a display 624, etc.; one or more devices that enable a user to interact with computer system 602; and/or any devices (e.g., network card, modem, etc.) that enable the premises-based protection system 110 and/or the cloud-based protection system 124 to communicate with one or more other computing devices. Such communication can occur via Input/Output (I/O) interfaces 622. Still yet, computer system 602 can communicate with one or more networks such as a local area network (LAN), a general wide area network (WAN), and/or a public network (e.g., the Internet) via network adapter 620. As depicted, network adapter 620 communicates with the other components of network system 100 via bus 618. It should be understood that although not shown, other hardware and/or software components could be used in conjunction with computer system 602. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Potential advantages provided by the ability of the premises-based protection to detect threshold exceeding behavior associated with particular targets and to request cloud-based protection for specific targets increases the speed in which an attack can be detected and thwarted using cloud-based protection. Cloud-based protection can be aggressive and more effective at blocking attack traffic destined for identified targets. Additionally, cloud-based protection can avoid applying countermeasures to network traffic that is destined for different targets that were not identified as targets of a large-scale attack, thus avoiding potential blocking of legitimate traffic to untargeted hosts.

Cloud-based protection can also be configured to automatically divert traffic to the cloud-based protection system for mitigation based on specific destinations specified in the cloud-request. This feature can increase speed of response and diversion of traffic to the cloud-based protection system, wherein the cloud-based protection system has more bandwidth available to mitigate the attack than the premises-based protection system. The increase in speed of response and traffic diversion can reduce the amount of legitimate traffic that inadvertently dropped during an attack, since the mitigation in the cloud happens sooner when targeted mitigation for specific destinations is applied. The increase in speed of response and traffic diversion can also eliminate the need for human intervention, thus reducing delays associated with human intervention and complications associated with expertise requirements.

The techniques described herein are exemplary, and should not be construed as implying any particular limitation of the certain illustrated embodiments. It should be understood that various alternatives, combinations, and modifications could be devised by those skilled in the art. For example, operations associated with the processes described herein can be performed in any order, unless otherwise specified or dictated by the operations themselves. The present disclosure is intended to embrace all such alternatives, modifications and variances that fall within the scope of the appended claims.

The terms “comprises” or “comprising” are to be interpreted as specifying the presence of the stated features, integers, operations or components, but not precluding the presence of one or more other features, integers, operations or components or groups thereof.

Although the systems and methods of the subject disclosure have been described with respect to the embodiments disclosed above, those skilled in the art will readily appreciate that changes and modifications may be made thereto without departing from the spirit and scope of the certain illustrated embodiments as defined by the appended claims.

1. A premises-based network protection system comprising:
a memory configured to store instructions;
a premises-based processor disposed in communication with the memory, wherein the processor upon execution of the instructions is configured to:
receive notification that a characteristic of premises-based network traffic associated with at least one identified target of a network attack exceeds a predetermined threshold; and
submit, based on the notification, a request, that identifies the at least one identified target, to a cloud-based protection system to provide cloud-based threat mitigation for a portion of the network traffic associated with the at least one identified target.

2. The premises-based network protection system of claim 1, wherein the target of the attack is at least one host that is a proper subset of a plurality of hosts, the plurality of hosts being coupled to a protected network, wherein the network traffic associated with the at least one host has a destination to the at least one host.

3. The premises-based network protection system of claim 1, wherein the target of the attack is a specified application or a specified network protocol, as specified by at least one of port, protocol, and/or payload information in the network traffic associated with the specified network protocol uses the specified network protocol.

4. The premises-based network protection system of claim 1, wherein the processor, upon execution of the instructions, is further configured to detect the characteristic of the network traffic using on-premises packet based inspection.

5. The premises-based network protection system of claim 1, wherein the characteristic of network traffic includes a measurement of network traffic associated with the at least one identified target, wherein the measurement is at least one of traffic rate or volume, or change in traffic rate or volume.

6. The premises-based network protection system of claim 1, wherein the cloud-based protection system has the capacity to mitigate a higher attack volume than attack mitigation provided by the on-premises network protection system.

7. The premises-based network protection system of claim 1, wherein the notification is in response to at least one of an operator generated request and an automatically generated request for cloud-based threat mitigation of the network traffic associated with the at least one identified target.

8. The premises-based network protection system of claim 1, wherein the predetermined threshold is user selected.

9. A computer-implemented method for providing premises-based network protection to a protected network, the method comprising:
receiving a notification signal that a characteristic of premises-based network traffic associated with at least one identified target of a network attack exceeds a predetermined threshold; and
submitting based on the notification signal, a request, that identifies the at least one identified target, to a cloud-based protection system to provide cloud-based threat mitigation for a portion of the network traffic associated with the at least one identified target.

10. The method of claim 9, wherein the target of the attack is at least one host that is a proper subset of a plurality of hosts, the plurality of hosts being coupled to a protected network, wherein the network traffic associated with the at least one host has a destination to the at least one host.

11. The method of claim 9, wherein the target of the attack is a specified application or a specified network protocol, as specified by at least one of port, protocol, and/or payload information in the network traffic associated with the specified network protocol uses the specified network protocol.

12. The method of claim 9, further comprising detecting the characteristic of the network traffic using on-premises packet based inspection.

13. The method of claim 9, wherein the characteristic of network traffic includes a measurement of network traffic associated with the identified target, wherein the measurement is at least one of traffic rate or volume, or change in traffic rate or volume.

14. The method of claim 9, wherein the cloud-based protection system has the capacity to mitigate a higher attack volume than attack mitigation provided by the on-premises network protection system.

15. The method of claim 9, wherein receiving the notification signal includes receiving at least one of an operator generated request and an automatically generated request for cloud-based threat mitigation of the network traffic associated with the identified target.

16. The method of claim 9, further comprising receiving the thresholds from a user as user input signals.

17. A non-transitory computer readable storage medium and one or more computer programs embedded therein, the computer programs comprising instructions, which when executed by a premises-based computer system, cause the computer system to:
receive notification that a characteristic of premises-based network traffic associated with at least one identified target of a network attack exceeds a predetermined threshold; and
submit, based on the notification, a request, that identifies the at least one identified target, to a cloud-based protection system to provide cloud-based threat mitigation for a portion of the network traffic associated with the at least one identified target.

18. The non-transitory computer readable storage medium of claim 17, wherein the target of the attack is at least one host that is a proper subset of a plurality of hosts, the plurality of hosts being coupled to a protected network, wherein the network traffic associated with the at least one host has a destination to the at least one host.

19. The non-transitory computer readable storage medium of claim 17, wherein the target of the attack is a specified application or a specified network protocol as specified by at least one of port, protocol, and/or payload information in the network traffic associated with the specified network protocol uses the specified network protocol.

20. The non-transitory computer readable storage medium of claim 17, wherein the computer program instructions, when executed by the computer system, further cause the computer system to detect the characteristic of the network traffic using premises-based packet based inspection.
